(19) United States
(12) Patent Application Publication
(10) Pub. No.: US 2004/0197009 A1
(43) Pub. Date: Oct. 7, 2004

(54) Method of optically recognizing postal articles using a plurality of images

(75) Inventor: Benyoub Belkacem, Palaiseau (FR)

Correspondence Address: SUGHRUE MION, PLLC, 2100 PENNSYLVANIA AVENUE, N.W., SUITE 800, WASHINGTON, DC, 20037, US

(73) Assignee: SOLYSTIC

(21) Appl. No.: 10/778,200

(22) Filed: Feb. 17, 2004

(30) Foreign Application Priority Data
Feb. 19, 2003 (FR) 03 01997

(51) Int. Cl. G06K 9/00

(52) U.S. Cl. 382/101

(57) ABSTRACT

A method of processing postal articles in an automatic address-reading system in which a multi-level gray scale image is formed of the surface of each article including address information, the multi-level gray scale image is transformed into a first binary image and the binary image is sent to an OCR unit for a first automatic evaluation of the address information, wherein a signature representative of a category of address information marks is extracted from the multi-level gray scale image and/or the binary image and/or the result of automatic data evaluation, the multi-level gray scale image is transformed again into a second binary image taking account of the category represented by said signature, and the second binary image is sent to an OCR unit in order to perform a second automatic evaluation.

The invention relates to a method of processing postal articles in an automatic address-reading system in which a multi-level gray scale image is formed of the surface of each article including address information, the multi-level gray scale image is transformed into a first binary image, and the binary image is sent to an optical character reader (OCR) unit for a first automatic evaluation of the address information.

This method is most particularly applicable to an automatic postal sorting installation in which automatic evaluation of address information is used for outward and inward postal sorting.

### BACKGROUND OF THE INVENTION

In known methods of processing postal articles of the kind mentioned above, the process of converting a multi-level gray scale image into a binary image implements algorithms of ever increasing sophistication in coping with the variety of images that need to be processed. More particularly, algorithms have been developed that attempt to binarize multi-level gray scale images in which the address information is hard to read because of low contrast between the marks of the address information and the background of the image, in which .the characters of the address information are more or less widely spaced apart from one another depending on whether they are handwritten or else printed by machine which might be a dot-matrix printer, a laser printer, etc . . . .

In spite of the improved performance of such binarization algorithms, in practice, batches of postal articles in an automatic postal sorting installation still contain postal articles which are rejected on processing for failure to achieve unambiguous recognition of address information because of inadequate binarization or in which the address information is read wrongly because of inadequate binarization.

U.S. Pat. No. 6,282,314 discloses a method of analyzing images that might contain characters and tables, in which the image is binarized in order to isolate portions of the image containing characters that can be read by OCR. U.S. Pat. No. 4,747,149 discloses a method of analyzing images in which binarization is performed in a plurality of different manners in parallel, and OCR processing is applied to the best binary image.

### OBJECT AND SUMMARY OF THE INVENTION

The object of the invention is to propose an improvement to a method of processing articles as specified above in order to obtain an increase in read success rate and a reduction in error rate.

To this end, the invention provides a method of processing postal articles in an automatic address-reading system in which a multi-level gray scale image is formed of the surface of each article including address information, the multi-level gray scale image is transformed into a first binary image and the binary image is sent to an OCR unit for a first automatic evaluation of the address information, wherein a signature representative of a category of address information marks is extracted from the multi-level gray scale image and/or the binary image and/or the result of automatic data evaluation, the multi-level gray scale image is transformed again into a second binary image taking account of the category represented by said signature, and the second binary image is sent to an OCR unit in order to perform a second automatic evaluation.

The method of the invention presents the following features:

the data constituting the signature comprises first statistical data indicative of the level of contrast in the address information marks of the multi-level gray scale image, second statistical data indicative of the typographical quality of the address information marks in the first binary image, third data indicative of the type of address information marks (handwritten image or machine-printed marks), and fourth statistical data about the quality of word and character recognition;

the second transformation of the multi-level gray scale image into a binary image consists in applying a specific binarization process selected from a plurality of binarization processes as a function of the category of the address information marks;

the specific processing is selected by means of a classifier receiving as its input the data constituting the signature; and

the results of the first automatic evaluation and of the second automatic evaluation are combined in order to obtain the address information.

In the method of the invention, the first transformation of the multi-level gray scale image implements a binarization algorithm that is said to be “general-purpose” in the sense that this algorithm is not specifically adapted to any particular category of address information marks. The term “categories of marks” is used to mean categories in which marks are classified depending on whether the marks are handwritten or the result of machine printing; marks written with low contrast in the multi-level gray scale image or marks written with a high level of contrast in the multi-level gray scale image; marks printed with a dot-matrix printing machine or marks written as characters printed by a laser printing machine; marks in which characters are disjoint or marks in which characters are joined up, etc. . . . . The person skilled in the art is aware of “general-purpose” binarization algorithms that function in statistically satisfactory manner on a broad spectrum of categories of address information marks.

In contrast the second transformation of the multi-level gray scale image implement a binarization algorithm that is specialized in the sense that this algorithm is adapted specifically to one category of address information marks. As non-limiting examples, the person skilled in the art is aware that a binarization algorithm based on Laplacian type convolution is suitable for low-contrast images; a binarization algorithm based on statistical thresholding is suitable for high contrast images; a binarization algorithm based on lowpass filtering which averages out pixel values over a large neighborhood is suitable for marks resulting from printing by a dot-matrix printing machine; etc. . . .

### BRIEF DESCRIPTION OF THE DRAWINGS

An implementation of the method of the invention is described below and shown in the drawings.

FIG. 1 shows the method of the invention in the form of a block diagram.

FIG. 2 is a diagram showing how the results of two automatic evaluations are combined.

### MORE DETAILED DESCRIPTION

The idea on which the invention is based is thus applying second binarization processing to a multi-level gray scale image including address information after first automatic evaluation of the address information, the second binarization processing being better adapted than the first binarization processing to certain specific features of the address information marks.

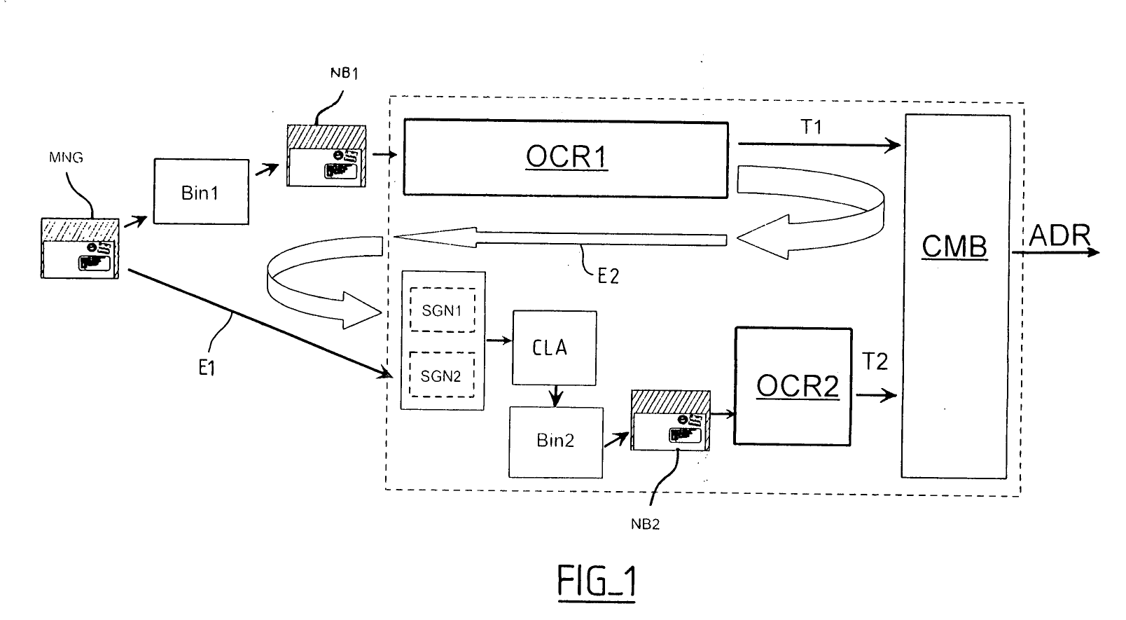

In FIG. 1, a multi-level gray scale image MNG of the surface of a postal article including address information is thus initially transformed by general-purpose first binarization processing Bin1 into a first binary image NB1.

The first binary image NB1 is applied to an OCR unit for first automatic evaluation OCR1 of the address information.

Data constituting a signature SGN1, SGN2 is extracted from the multi-level gray scale image MNG and/or from the binary image NB1 and/or from the results of the automatic evaluation OCR1. The extraction of this data is represented by arrows E1 and E2.

By way of example, signature portion SGN1 contains:

data extracted from the automatic evaluation OCR1 together with indications concerning the type of the address information marks (handwritten/machine printed);

the coordinates in two dimensions of the address block in the binary image obtained by the processing OCR1;

statistical data extracted from the binary image Bin1 and from the automatic evaluation OCR1 and indicative of the typographical quality of the address information marks: mean densities of interconnected components (strings of pixels in the binary image); number of interconnected components per character in the address information; number of characters per interconnected component; number of parasites per character; mean of the recognition scores of the best candidates over the entire address block.

The signature portion SGN2 contains, for example, statistical data extracted from the multi-level gray scale image representative of the contrast level of the address information marks in the multi-level gray scale image: mean gray level of characters in the multi-level gray scale image; standard deviation of the histogram of character gray levels; mean gray level of the background of the multi-level gray scale image; standard deviation of the histogram of the background of the multi-level gray scale image.

This extracted data constitutes the signature SGN1, SGN2 used for categorizing the address information marks in each multi-level gray scale image MNG. The categorization data can be input to a classifier CLA suitable for identifying the category of the address information marks and thus the specialized binarization treatment from a plurality of specialized binarization treatments that is best suited to the category of the marks. Thereafter, the multi-level gray scale image MNG is subjected to the specialized binarization processing given by Bin2 and identified by the classifier CLA.

The person skilled in the art knows specialized binarization algorithms such as Bin2 for binarizing images having a noisy background, images in which address information is handwritten, images in which address information is typewritten, etc. . . . . Depending on circumstances, these algorithms make use, amongst other options, of adaptive contrast, differential operators, lowpass operators, or indeed dynamic thresholding.

The second binary image NB2 can then be applied to an OCR unit for second automatic evaluation OCR2 of the address information.

By way of example, the classifier CLA can be a neural network with supervised training or an expert system having a knowledge base operating with fuzzy logic.

With the method of the invention, it has been found that by combining the results T1 and T2 of the two automatic evaluations OCR1 and OCR2 it is possible to obtain a read success rate after such combination that is better than the read success rate after the first automatic evaluation OCR1 and that is also better than the read success rate after the second automatic evaluation OCR2.

It has thus been found that by combining the results T1 and T2 as output respectively by the first automatic evaluation OCR1 and by the second automatic evaluation OCR2, it is possible to reduce the overall error rate by comparing the particular error rate obtained at the output from the first automatic evaluation with the error rate obtained at the output from the second automatic evaluation.

In FIG. 1, the block referenced CMB represents the process of combining the results T1 and T2. This combining process can consist in using result vectors produced at the outputs from the OCR units performing the first and second automatic evaluations together with the confidence levels associated with the result vectors. The combination process can also make use of an expert system enabling address hypotheses to be correlated by using links obtained at semantic level via the address database. The advantage of this process of combining the results T1 and T2 is that it makes it possible specifically to improve the read success rate on the binary images NB2 in the event of the address information resulting from the treatment OCR1 being rejected; it improves the overall read success rate by the treatment OCR2 recycling the results of classification by the treatment OCR1.

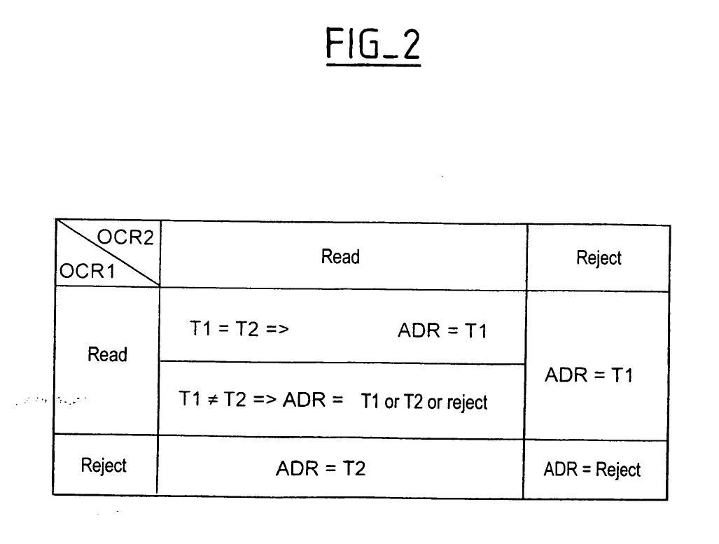

More particularly, and with reference to FIG. 2, the treatments OCR1 and OCR2 might have extracted one or two items of contextual address information, or perhaps none in the event of failure of both binary images NB1 and NB2. In accordance with the invention, combining CMB the contextual address information T1 and T2 consists in forming address information ADR when two items of contextual information T1 and T2 have been read and are correlated, which is symbolized by T1=T2=>ADR=T1. If only one item of contextual information T1 or T2 is read, it is retained as being the looked-for address information, as is symbolized by the blocks ADR=T1 or ADR=T2. If two contradictory items of contextual information T1 and T2 are read, arbitration is necessary, taking account of the respective confidence levels of the items of contextual information T1 and T2 in order to determine which address ADR is to be retained, which is symbolized by T1≠T2=>T1 or T2 or “reject” in FIG. 2. Finally, no address information is formed if no item of contextual information is extracted from the binary images NB1 and NB2, which corresponds to the block ADR=reject.

What is claimed is:

1. A method of processing postal articles in an automatic address-reading system in which a multi-level gray scale image is formed of the surface of each article including address information, the multi-level gray scale image is transformed into a first binary image and the binary image is sent to an OCR unit for a first automatic evaluation of the address information, wherein a signature representative of a category of address information marks is extracted from the multi-level gray scale image and/or the binary image and/or the result of automatic data evaluation, the multi-level gray scale image is transformed again into a second binary image taking account of the category represented by said signature, and the second binary image is sent to an OCR unit in order to perform a second automatic evaluation.

2. The method according to claim 1, in which the data constituting the signature comprises statistical data concerning the multi-level gray scale image, statistical data concerning the first binary image, and statistical data concerning the recognition of words and characters delivered by the first automatic evaluation.

3. The method according to claim 1, in which the data constituting the signature comprises first statistical data indicative of the level of contrast in the address information marks of the multi-level gray scale image, second statistical data indicative of the typographical quality of the address information marks in the first binary image, third data indicative of the type of address information marks (handwritten image or machine-printed marks), and fourth statistical data about the quality of word and character recognition.

4. The method according to claim 1, in which the second transformation of the multi-level gray scale image into a binary image consists in applying a specific binarization process selected from a plurality of binarization processes as a function of the category of the address information marks.

5. The method according to claim 4, in which the specific processing is selected by means of a classifier receiving as its input the data constituting the signature.

6. The method according to claim 5, in which the classifier is a neural network with supervised training.

7. The method according to claim 1, in which the results of the first automatic evaluation and of the second automatic evaluation are combined in order to obtain the address information.
